(19) United States
(12) Patent Application Publication
(10) Pub. No.: US 2019/0197511 A1
(43) Pub. Date: Jun. 27, 2019

(54) METHOD AND APPARATUS FOR PROCESSING INFORMATION

(71) Applicant: ALIBABA GROUP HOLDING LIMITED, George Town (KY)

(72) Inventors: Yicong FAN, Hangzhou (CN); Xuezhang LU, Hangzhou (CN); Shunping YAN, Hangzhou (CN); Ping LU, Hangzhou (CN)

(21) Appl. No.: 16/286,469

(22) Filed: Feb. 26, 2019

Related U.S. Application Data
(63) Continuation of application No. PCT/CN2017/097306, filed on Aug. 14, 2017.

(30) Foreign Application Priority Data
Aug. 26, 2016 (CN) 201610742600.4

(51) Int. Cl. G06Q 20/28; G06Q 20/10

(52) U.S. Cl. CPC G06Q 20/28; G06Q 20/10

(57) ABSTRACT

Embodiments of the disclosure provide methods and apparatuses for processing information. The method can include: receiving, via a server, an exchange request for a first transaction order associated with a first user and a second user; determining first user information of the first user, second user information of the second user, and information of a first data object associated with the exchange request; verifying the second user; and in response to the second user being verified, creating a second transaction order according to the information of the first data object; and providing the second transaction order to a client terminal of the first user for execution of a delivery of the first data object, wherein the second transaction order is associated with a second data object corresponding to the first data object.

### CROSS REFERENCE TO RELATED APPLICATION

The disclosure claims the benefits of priority to International Application Number PCT/CN2017/097306, filed Aug. 14, 2017, which claims priority to Chinese Application Number 201610742600.4, filed Aug. 26, 2016, both of which are incorporated herein by reference in their entireties.

### BACKGROUND

A transaction platform may include a variety of users, such as a provisioning user and a consuming user. The provisioning user may list a data object on the platform and provide detailed information about the data object. The consuming user may browse information of the data object listed by the provisioning user via a client or a webpage, and may purchase the data object. The provisioning user may select and buy the data object by placing an order online. If the data object is associated with physical goods, the provisioning user can deliver, upon receiving the order, the physical goods to a delivery address designated by the consuming user using logistics service.

Upon receiving the goods, the consuming user may request goods exchange if the size, color, or style of the goods is not desirable. For example, the goods A having a size M can be exchanged with the goods A having a size S, the red goods B can be exchanged with the white goods B, and the like.

Conventionally, if the consuming user exchanges goods after receiving the goods, the consuming user may have to inform the provisioning user. When an agreement is reached, the consuming user may submit an application for goods exchange provided by the platform and send the received goods (i.e., “returned goods”) to the provisioning user via express delivery. After receiving the returned goods from the consuming user and confirming the integrity of the returned goods for secondary sales, the provisioning user can then send desired goods (which can be referred to as “exchanged goods”) to the consuming user via express delivery. Such a process leads to a period of about 5 to 7 days, or even longer, for the consuming user to receive the exchanged goods. The efficiency of the exchange process is low.

In summary, how to improve the efficiency of the goods exchange process has become a technical problem to be addressed.

### SUMMARY OF THE DISCLOSURE

The present application provides a goods exchange information processing method and apparatus, which can provide a fast goods exchange processing mode for a user with a good credit rating, shorten the period of the goods exchange process, and improve the efficiency of the goods exchange process.

In an aspect, embodiments of the disclosure provide a method for processing information. The method can include: receiving, via a server, an exchange request for a first transaction order associated with a first user and a second user; determining first user information of the first user, second user information of the second user, and information of a first data object associated with the exchange request; verifying the second user; and in response to the second user being verified, creating a second transaction order according to the information of the first data object; and providing the second transaction order to a client terminal of the first user for execution of a delivery of the first data object, wherein the second transaction order is associated with a second data object corresponding to the first data object.

In another aspect, embodiments of the disclosure provide an apparatus for processing information. The apparatus can include: a memory storing a set of instructions; and at least one processor configured to execute the set of instruction to cause the apparatus to perform: receiving an exchange request for a first transaction order associated with a first user and a second user; determining first user information of the first user, second user information of the second user, and information of a first data object associated with the exchange request; verifying the second user; and in response to the second user being verified, creating a second transaction order according to the information of the first data object; and providing the second transaction order to a client terminal of the first user for execution of a delivery of the first data object, wherein the second transaction order is associated with a second data object corresponding to the first data object.

In yet another aspect, embodiments of the disclosure provide a non-transitory computer-readable medium that stores a set of instruction that is executable by at least one processor of a sever to cause the sever to perform a method for processing information. The method can include: receiving an exchange request for a first transaction order associated with a first user and a second user; determining first user information of the first user, second user information of the second user, and information of a first data object associated with the exchange request; verifying the second user; and in response to the second user being verified, creating a second transaction order according to the information of the first data object; and providing the second transaction order to a client terminal of the first user for execution of a delivery of the first data object, wherein the second transaction order is associated with a second data object corresponding to the first data object.

### BRIEF DESCRIPTION OF THE DRAWINGS

To more clearly describe technical solutions in the embodiments of the present application or current technologies, the accompanying drawings to be used in the embodiments will be briefly described below. Obviously, the accompanying drawings in the following description are merely some embodiments of the present application. To a person skilled in the art, other drawings may be further derived from these accompanying drawings without creative effort.

FIG. 1 is a block diagram of a system, according to embodiments of the present application.

FIG. 2 is a flowchart of an information processing method for exchanging goods, according to embodiments of the application.

FIG. 3 is an exemplary flow chart of a goods exchange process, according to embodiments of the present application.

FIG. 4 is a schematic diagram of a transfer direction of payments for goods in the exemplary flow chart, according to embodiments of the present application.

FIG. 5 is a flow chart of a method for processing information, according to embodiments of the present application.

FIG. 6 is a flow chart of a method for processing goods exchange information, according to embodiments of the present application.

FIG. 7 is a schematic diagram of an apparatus for processing goods exchange information, according to embodiments of the present application.

FIG. 8 is a schematic diagram of an apparatus for processing goods exchange information, according to embodiments of the present application.

FIG. 9 is a schematic diagram of an apparatus for processing goods exchange information, according to embodiments of the present application.

### DETAILED DESCRIPTION

The technical solutions in the embodiments of the present application will be described below clearly and completely with reference to the accompanying drawings in the embodiments of the present application. Apparently, the described embodiments are merely some, rather than all, of the embodiments of the present application. On the basis of the embodiments of the present application, all other embodiments obtainable by a person skilled in the art shall fall within the scope of the present invention.

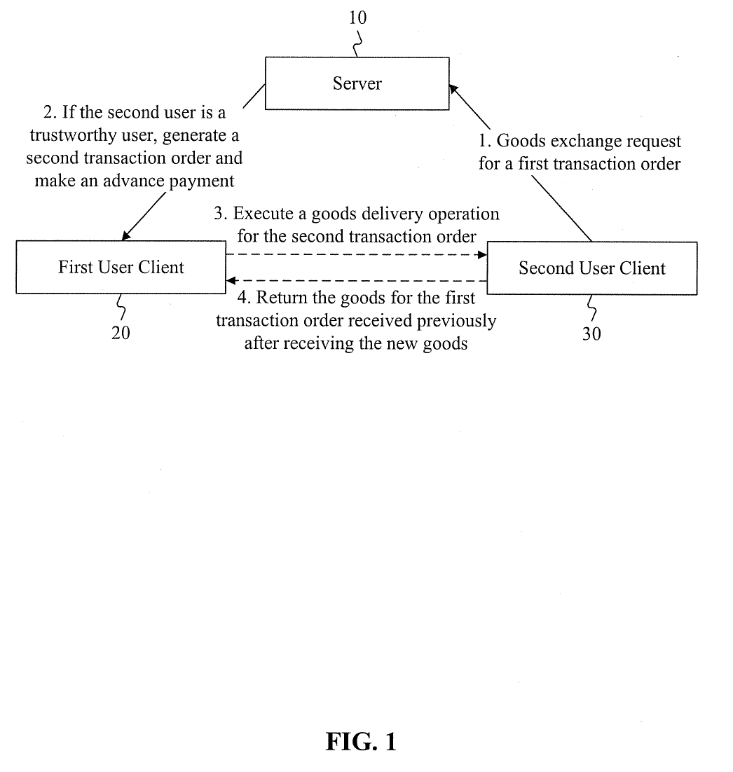

FIG. 1 illustrates an information processing system 100 for exchanging goods, according to embodiments of the disclosure. System 100 can include a server 10 of a transaction platform, a first user client 20, and a second user client 30. Server 10 can receive an exchange request for a first transaction order filed by second user client 30, and determine information associated with the exchange request. The information associated with the exchange request can include first user information, second user information, and first data object information. When the second user is verified (e.g., verifying a credit authorization of the second user), the server can create a second transaction order according to the first data object information and provide the second transaction order to first user client 20. Therefore, a fast exchange mode can be provided. For example, when a credit rating of a second user satisfies a threshold and this second user is not satisfied with a purchased data object (e.g., a second data object), the second user can request goods exchange (e.g., exchanged to the first data object). Server 10 can create a new transaction order according to the first data object information associated with the goods exchange request, and provide the new transaction order to the first user. The first user can execute a goods delivery operation on the first data object according to the new transaction order, without waiting for the second data object returned by the second users before delivering the goods. Therefore, the period for the second user receiving the first data object can be shortened, and therefore the period of the entire goods exchange process can be shortened and the efficiency of the goods exchange process can be improved.

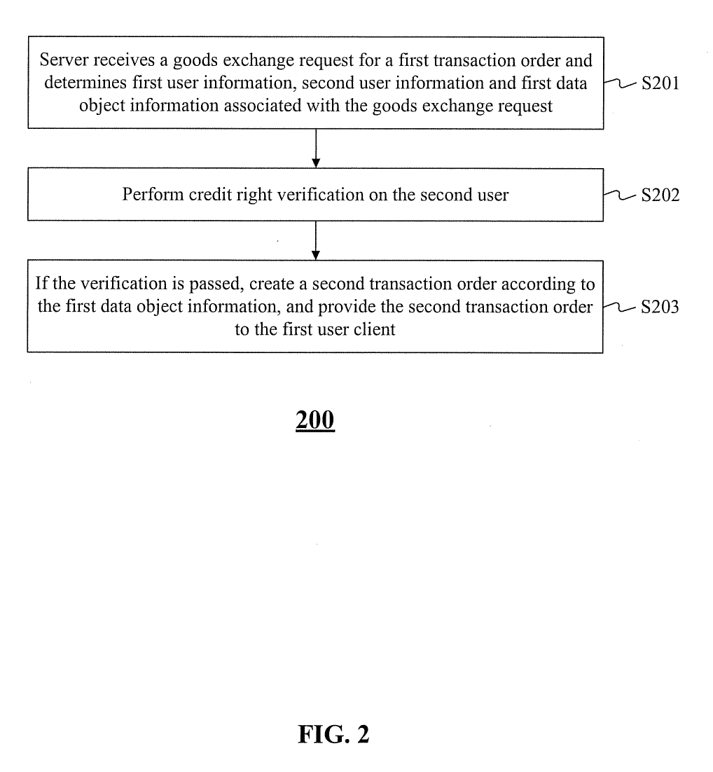

FIG. 2 is a flowchart of an information processing method 200 for exchanging goods, according to embodiments of the application. Method 200 can be implemented by a server and include following steps S201-S203.

In step S201, the server receives a goods exchange request for a first transaction order. The goods exchange request can include first user information, second user information, and first data object information.

The first transaction order can be created according to a purchase operation of a data object selected by the second user. The data object can include a merchandise object, a service, and the like on an e-commerce transaction platform. The selection of the data object can trigger the purchase operation.

On the basis of the transaction order, the server typically can provide a variety of operation options for the second user according to conditions. For example, the operation options can include “Cancel Order,” “Confirm Receipt,” “Return Goods,” “Exchange Goods,” “Evaluation,” and the like. In some embodiments, “Cancel Order” can be provided within a preset period of time after the order is generated, “Confirm Receipt” can be provided after the first user has executed a goods delivery operation, “Return Goods” can be provided after the first user has executed a goods delivery operation, “Exchange Goods” can be provided after the first user has executed a goods delivery operation, “Evaluation” can be provided after the second user has executed a goods receipt confirmation operation.

Accordingly, the second user can initiate a corresponding request by operating the above operation options, and the second user client can submit the request to the server. For example, after receiving the second data object associated with the first transaction order from the first user, the second user can initiate a goods exchange request through the operation option of “Exchange Goods.” The second user client can submit the goods exchange request to the server, and the server can provide a goods exchange request message to the first user client, so that the first user performs relevant operations.

In some embodiments, when a second user initiates a goods exchange request through the operation option of “Exchange Goods,” operation options for filling information related to the goods exchange request can also be provided. The information related to the goods exchange request can include a name of the goods to be exchanged, reason for the exchange, description of goods exchange, pickup address, and the like, The information related to the goods exchange request can be collected and submitted to a server, and the server can further send the goods exchange request first to a first user associated with the first transaction order.

Upon receiving the goods exchange request information, the first user can decide whether to approve the goods exchange request. In some embodiments, a server can provide a first user with operation options, such as “Approve Goods Exchange” and “Reject Goods Exchange.” The first user can send a notification message of approving goods exchange or rejecting goods exchange through the operation option of “Approve Goods Exchange” or “Reject Goods Exchange.”

When the first user clicks the operation option of “Approve Goods Exchange,” the first user client can submit the notification message of approving goods exchange to the server.

Subsequently, the server can determine first user information (e.g., a first user identifier, a receiving address of the first user, and the like), second user information (e.g., a second user identifier, a receiving address of the second user, and the like), and first data object information (e.g., name, specifications, resource information, and the like of the first data object) associated with the goods exchange request according to the first transaction order and goods exchange request-related information.

It should be noted that, a goods exchange service can only be provided to data objects of the same price. Because there is no price difference between two involved data objects, no economic loss will be suffered by the platform, first user or second user during the goods exchange process.

In some embodiments, goods exchange can be performed between identical or different SKUs (Stock Keeping Unit) for the same data object of SPU (Standard Product Unit). For example, a second user purchased a cup A and found, upon receiving the cup A, that the cup A had a defect and would like to exchange for another cup. Then, the second user can initiate a goods exchange request. Or the second user purchased a white cup B and found, upon receiving the cup B, that the color was not desirable while the cup B sold by the first user has other colors at the same price. Then, the second user can initiate a goods exchange request.

In some embodiments, different data objects have the same price. For example, data objects sold by the first user include cup B and plate C, and the two are data objects of the same price. When the second user buys and receives the cup B, the second user wants to exchange to the plate C and then a goods exchange request can be initiated. Because the two data objects involved in the goods exchange process have the same price and there is no price gap, it can be ensured that the goods exchange process will not cause any economic loss to the first user or the second user.

In some embodiments, a goods exchange service can be provided to data objects of different prices. For example, the first user and the second user can reach an agreement on a manner for handling the price difference between the two data objects involved in the goods exchange process before goods exchange can be performed. Therefore, any economic loss to the first user or the second user caused by the price difference can be prevented.

In step S202, credit rating of the second user can be verified.

In some embodiments, credit rating of the second user can be verified in a variety of manners. For example, credit scores of the second users can be stored in a database of the server. Whether a credit score of a current second user is higher than a threshold value can be determined. If the credit score of the current second user is higher than the threshold value, the credit rating of the current second user is verified. For example, on the Alipay platform, the “Sesame Credit” information associated with an Alipay account of a second user can be obtained, a credit limit offered by the “Ant Credit Pay” to the second user can also be obtained, and the like. In addition, a set of second users with verified credit rating can also be stored in the database of the server. It can be determined whether the current second user belongs to this set. If the current second user belongs to this set, the credit rating of the current second user is verified.

In some embodiments, resource information of the first data object and credit limit information of the second user can be determined. The resource information can be associated with a price of the first data object. The second users can be divided into different levels, and different credit limits are provided to different levels. For example, a higher credit level can have a higher credit limit. In other words, if a second user has a good credit rating but a low credit level, the corresponding credit limit can be low. In some embodiments, the credit limit may not match the resource information associated with the current transaction order. For example, the credit limit can be less than the price of the first data object. In this case, a fast goods return mode may not be provided to the second user, and the second user can discuss with the first user regarding goods exchange via a conventional goods exchange route.

In some embodiments, the server can divide users with good credit rating into different credit levels in advance. For example, different ranges can be set for different levels. After a credit score is determined for a second user, the second user can be classified into a corresponding credit level according to the ranges. In addition, a corresponding relationship between credit levels and credit limits can be stored in e.g., in advance in the database of the server. For example, level 1 can correspond to 100 Yuan, level 2 can correspond to 200 Yuan, level 3 can correspond to 300 Yuan, and the like.

Therefore, whether the credit limit information of the second user matches the resource information of the first data object (e.g., the credit limits being greater than the price of the first data object) can be determined. And based on at least the above determination, whether the credit rating is verified can be determined. For example, if the credit limit information of the second user matches the resource information of the first data object, the credit rating can be verified. If the credit limit information of the second user does not match the resource information of the first data object, the credit rating cannot be verified.

In an example, the current second user has a credit level of 2 and a corresponding credit limit of 200 Yuan. The price of the first data object in the current transaction order is 120 Yuan. It can be determined that the credit limit information of the current second user matches the price of the first data object, and the credit rating can be verified.

To prevent a second user from misusing the goods exchange function, a number of requests for goods exchange by a same second user within a given period of time can be further limited, so as to prevent the same second user from frequently exchanging goods in a short period of time. For example, when the credit limit information of the current second user matches the resource information of the first data object, the number of requests for goods exchange initiated by the current second user within the given period of time (e.g., the most recent half a month) can be further counted. Verification on the credit rating can be further performed based on the counting results. If the counting result is smaller than a preset threshold value (e.g., the preset threshold value is two times), the credit rating can be verified.

In step S203, in response to the credit rating being verified, a second transaction order can be created according to the first data object information to be provided to the first user client. Therefore, the first user can execute a goods delivery operation of the first data object according to the second transaction order.

For example, if the credit rating of the current second user satisfies a threshold, the second transaction order can be created according to a name, specifications, resource information, and the like of the first data object. The first user can execute a goods delivery operation of the first data object according to the second transaction order, without receiving the second data object associated with the first transaction order returned by the second users. Therefore, the period that the second user receives the first data object can be shortened, which shortens the period of the entire goods exchange process and improves the efficiency of the goods exchange process. If the credit rating of the current second user fails to satisfy the threshold, the second user can negotiate with the first user regarding goods exchange via a conventional goods return route.

In some embodiments, when the second user requests an order for the goods exchange, the second user is not required to further pay for the goods exchange. Therefore, from the perspective of the first user, the order for the goods exchange is an order of zero Yuan. Therefore, to safeguard interests of the first user and to avoid concerns that the first user has regarding goods delivery due to the “order of zero Yuan,” the resource information of the first data object associated with the goods exchange request can be further determined after the second transaction order is created. Then an operation of advance payment can be provided on the second transaction order. To implement the advance payment, the platform can further set up an advance payment account and deposit an amount (e.g., 300,000 Yuan) into this advance payment account, such that the advance payment account can be used for an advance payment. As such, after the second transaction order is created, the advance payment account can be used for the amount of the first goods associated with the second transaction order. For example, corresponding resource information can be forwarded to a beneficiary's account associated with the corresponding first user.

Alternatively, the platform can further provide an intermediary account (for example, an escrow account on the Alipay platform) during normal transactions between a first user and a second user. When the second user makes a payment for an order, the resource information corresponding to the order can be transferred into the intermediary account. When the first user has shipped out the goods and the second user confirms the receipt of the goods, the resource information can be then transferred from the intermediary account into a beneficiary's account of the first user. In embodiments of the present application, when there is an intermediary account on a platform, resource information for advance payment can be first transferred into the intermediary account. A first notification message for successful payment can be provided to the first user client, such that the first user can executes a goods delivery operation on the first data object after receiving the second transaction order and the first notification message. Subsequently, when the first user confirms the receipt of the first data object returned by the second user, this part of resource information for advance payment is then transferred from the intermediary account into an account of the first user. As such, the system (e.g., the platform) can first execute an advance payment operation through the advance payment account for a transaction order created for a goods exchange operation. The advance payment provided by system can avoid the concerns of the first user regarding whether an associated resource can be promptly received after receiving an “order of zero Yuan,” and therefore secure the economic interest of the first user. The advance payment provided by system can also cause the first user to promptly execute a goods delivery operation upon receiving a relevant transaction order and a successful payment message. Accordingly, the second user can receive the first data object as early as possible, thereby shortening the entire goods exchange process. Furthermore, by the transfer through the intermediary account, the security and reliability of resource information turnover is further guaranteed.

In some embodiments, when a newly created second transaction order is provided to the first user client, a variety of operation options can also be provided. For example, as the second transaction order is created based on a goods return request by the second user, the first user can, in addition to executing a goods delivery operation on a second data object, subsequently receive the first data object returned by the second user. Therefore, in the process of displaying information of the second transaction order on the first user client, an operation option for executing “Confirm Receipt” can be further provided. When the first user receives the first data object returned by the second user, a second notification message for confirming the receipt can be submitted to the server through the operation option “Confirm Receipt.” According to the second notification message, the server can transfer the resource information of the advance payment for the second transaction order into an account associated with the first user. In other words, when the first user receives the returned first data object, the server can transfer the resource information of the advance payment for the second transaction order from the intermediary account into an account associated with the first user.

In addition, when the platform provides the intermediary account, the resource information of the first transaction order can be also temporarily stored in the intermediary account. In other words, after the second user sends out a goods exchange request for the first transaction order, the platform creates the second transaction order, and makes an advance payment, the resource information of the first transaction order and the resource information of the second transaction order can be both temporarily stored in the intermediary account. Therefore, when the first user confirms the receipt of the second data object returned by the second user, the resource information associated with the second transaction order can be transferred from the intermediary account into the account associated with the first user. Moreover, the resource information associated with the first transaction order can be returned from the intermediary account into the account associated with the second user. Then, the resource information associated with the second transaction order can be transferred from the account associated with the second user into the advance payment account, so as to ensure the balance between the advance payment resource and resource reflux in the advance payment account. As such, when the goods exchange process is completed, the resource information associated with the first transaction order can be returned to the second user, the resource information associated with the second transaction order can be transferred into the account associated with the first user, and the second user transfers the advance payment provided by the platform into the advance payment account of the platform. As a result, the advance payment account can achieve balance between income and expenses, the first user receives the resource information, and the second user pays corresponding resource information for obtaining a specific data object.

In some embodiments, there can be a variety of manners for transferring the resource information associated with the second transaction order from the account associated with the second user into the advance payment account. For example, the platform can send a message to the second user (e.g., a client terminal of the second user). According to the received message, the second user can transfer corresponding resource information from its own account into the advance payment account of the platform. In the above process, there are many operations for the second user to execute, including inputting a password, confirming, and the like. In embodiments of the present application, therefore, the platform can also implement a “withholding.” In other words, when the second user needs to transfer corresponding resource information into the advance payment account of the platform, the platform can also directly execute the above transfer operation, making it unnecessary for the second user to execute operations including inputting a password, confirming, and the like. In such a manner, a withholding permission of the second user can also be obtained in advance.

In some embodiments, to obtain the withholding permission of the second user, the server can provide the second user with an operation option for signing a withholding agreement. The second user can sign the withholding agreement through the operation option. After the second user has signed the withholding agreement, the withholding permission of the second user can be obtained, and the server can execute the above withholding. After the withholding operation is executed, the server can provide a notification message to the second user, informing the execution of the withholding. Therefore, operation steps can be reduced for the user, and provide greater security for the system. Situations, such as the second user forgetting to make a payment or waiting for a very long time to make a payment, can be avoided accordingly. The timeliness of fund reflux in the advance payment account can also be ensured.

In the goods exchange, the second user can return the second data object associated with the first transaction order to the first user. For example, conventionally, the second user typically can contact a logistics service provider for express delivery. In some embodiments, logistics distribution routes can be planned for the returned second data object associated with the first transaction order and the shipped first data object associated with the second transaction order. The logistics distribution resources can therefore be utilized in a more reasonable way to facilitate the second user to return the data object.

For example, the server can further provide an operation option of e.g., “Goods Delivery” in the second transaction order. For the second transaction order, the first user can send a third notification message through the operation option of “Goods Delivery,” indicating that the goods have been delivered for the second transaction order. The third notification message can be submitted to the server by the first user (e.g., using a client terminal). In addition, the server can submit the information of the logistics service provider selected at delivery to the server. For example, the server can provide the first user with an operation option for delivery logistics information, the first user can fill in delivery logistics information (e.g., name of the logistics company, logistics bill number, and the like) through the operation option, and can submit the delivery logistics information to the server.

Thus, the server can receive the third notification message submitted by the first user client that the goods have been delivered for the second transaction order, and can determine the information of the logistics service provider that executes the delivery task (e.g., name of the logistics company, logistics bill number, and the like).

Subsequently, first address information associated with the first user and second address information associated with the second user can be further extracted from the first user information and the second user information determined in S101.

Next, whether the logistics service provider can provide pickup services at the second address and provide delivery services at the first address can be determined, according to service coverage information (such as coverage of pickup services, coverage of delivery services, and the like) of the logistics service provider stored in the server.

When it is determined that the logistics service provider can provide pickup services at the second address and provide delivery services at the first address, the logistics order associated with the second transaction order can be marked. Thus, a deliverer can execute a goods pickup operation on the second data object to be returned by the second user according to the mark when the first data object is delivered to the second address, and distribute the second data object to the first address. As such, the second data object to be returned can be returned while the second user does not need to select and contact a logistics service provider on his/her own, reducing the operation steps by the second user and improves the user experience.

In some embodiments, the deliverer can install a phone application in a terminal device. The phone application may be provided by the logistics service provider to which the deliverer belongs. Alternatively, the phone application may be provided by the e-commerce platform. Through the phone application, the deliverer can execute an operation of e.g., “Grab Orders.” In other words, when the platform issues a new delivery task, the deliverer can receive a notification of a delivery task from the phone application and can accept the delivery task. Upon accepting the delivery task, the detailed information of corresponding logistics order can be sent to the terminal device of the deliverer, and the deliverer can execute delivery accordingly.

If a client terminal of the deliverer is provided by the logistics service provider, the platform can provide a Software Development Kit (SDK) to the logistics service provider, such that the logistics distribution service provider can receive notifications from the platform and mark corresponding logistics orders. The deliverer can use the logistics distribution application to view logistics orders and promptly find logistics orders having the mark, and execute matching distribution tasks.

If the client terminal of the deliverer is provided by the platform, the server of the platform can directly mark logistics orders associated with the second transaction order. When accepting corresponding distribution tasks, the deliverer can promptly find whether corresponding logistics orders are marked logistics orders and execute matching distribution tasks.

In addition, the first user identifier information, the second user identifier information, the first address information, and the second address information can be provided to the logistics service provider, such that the logistics service provider generates electronic information of receiver and sender for the distribution operation for the second data object and prints the electronic information on an “Express Delivery Bill.” Here, when the information of receiver and sender is generated, as the second data object is returned by the second user to the first user, the name, second geological information, contact information, and the like of the second user can be used as the sender information. Correspondingly, the name, first geological information, contact information, and the like of the first user can be used as the receiver information. As such, when the deliverer sends the first data object to the second address of the second user, the second user just needs to directly give the second data object to be returned to the deliverer there with no need to manually fill in the “Express Delivery Bill.” The deliverer can attach the printed Express Delivery Bill to the package of the second data object, and can give the “Customer Copy” of the Express Delivery Bill to the second user as a proof of delivery.

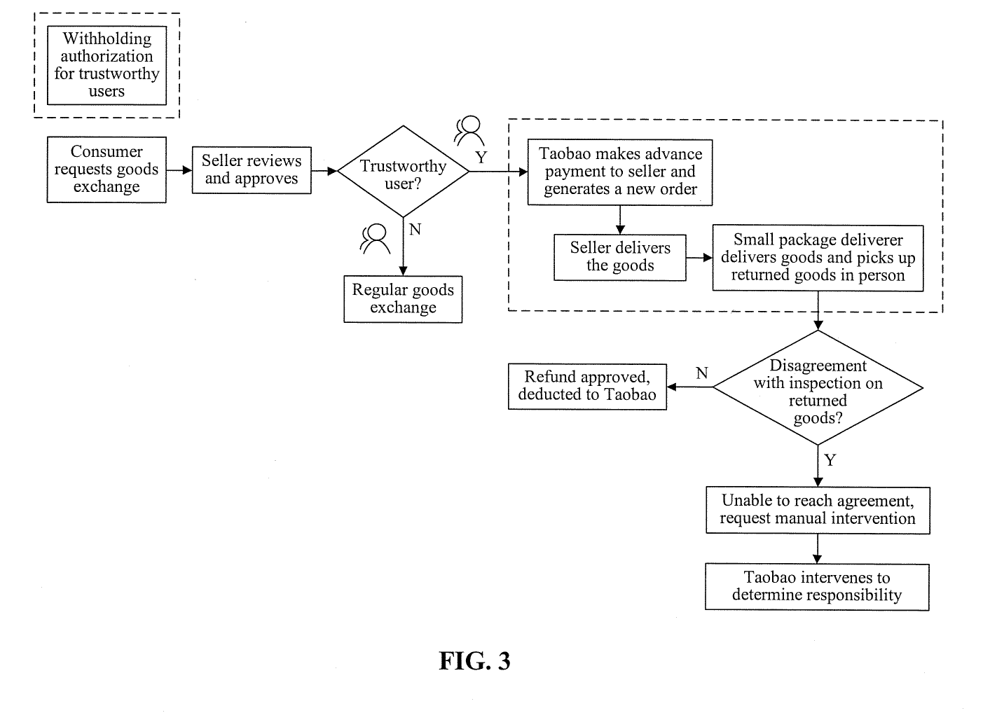

FIG. 3 is an exemplary flow chart of a goods exchange process, according to embodiments of the present application. In FIG. 3, the “Taobao” sales platform is used as an example. The platform has a “Taobao” intermediary account. On the platform of “Taobao,” the method for exchanging goods can include: performing withholding authorization for trustworthy users. In other words, with prior agreement of a user, the platform can directly perform withholding in subsequent refund processing and the user does not have to execute confirmation operations such as inputting a password. When a consumer requests goods exchange, the request can be sent to a seller for review. When the first user review is passed, the platform can determine whether the present consumer is a trustworthy user. If the present consumer is not a trustworthy user, a regular goods exchange process can be performed. Therefore, the first user (e.g., a provisioning user) has to further execute goods delivery when the first user receives the goods returned by the buyer. If the present consumer is a trustworthy user, the platform can make an advance payment to the first user and generate a new order. In such a way, the seller can execute a goods delivery operation according to the new order. When a package deliverer (e.g., the express deliveryman) can pick up the goods to be previously returned in person when delivering the goods of the new order to the buyer. In other words, the buyer can receive the new goods and return the previously received goods at the same time, which greatly reduce the wait time. Upon inspecting the returned goods and having no disagreements, the small package deliverer can notify the platform. As such, the platform can execute subsequent relevant operations such as refund, withholding, and the like. If there is a disagreement, the small package deliverer can discuss with the second user (e.g., consuming user). If no agreement can be reached, the platform can intervene and determine responsibilities.

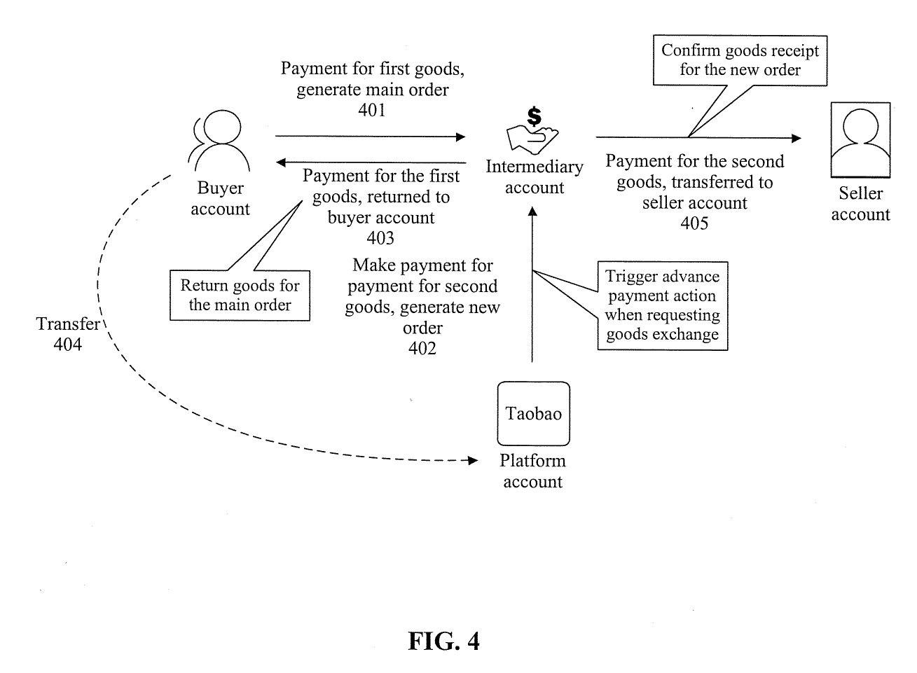

In the above process, the flow of payment for goods involve a number of accounts, including the buyer account, the seller account, the intermediary account, and the platform account (i.e., the advance payment account). The transfer direction of payment for goods at each stage of the flow is shown in FIG. 4. The stages of FIG. 4 include stages 401-405.

In stage 401, when the second user (e.g., consuming user) first generates an order, the second user can make payment for first goods from the buyer account into the intermediary account. Before the second user executes the operation of “Confirm Receipt” or before a time prescribed by the system expires (e.g., 10 days), this payment for goods will be temporarily retained in the intermediary account.

In stage 402, the user may request goods exchange upon receiving the goods from the seller. In this case, the second user may not click the button of “Confirm Receipt.” Instead, the second user may initiate a goods exchange request. When the seller approves the goods exchange and the platform determines that the present user is a trustworthy user, a new order can be generated, and the payment for second goods can be transferred from the platform account into the intermediary account. In other words, the advance payment account pays for the new order.

In stage 403, after the seller delivers the goods again and the second user receives the goods, the operation of “Confirm Receipt” can be executed based on the original order. In other words, the new order can be transparent to the second user, and the platform can record the association between the original main order and the new order generated at the time of goods exchange. At this moment, the payment for the first goods previously paid from the buyer account can be returned to the buyer account from the intermediary account.

In stage 404, as the advance payment account made an advance payment for the new order, the platform can transfer the payment for goods from the buyer account into the platform account after returning the payment for the first goods to the buyer account.

In stage 405, the platform then transfers the payment for the second goods paid for the new order from the intermediary account into the seller account.

It can be seen that in embodiments of the present application, the payment for goods is finally made from the buyer account, and the seller account also receives the payment for goods. The platform's advance payment account makes an advance payment earlier but pays it back through deduction later. Therefore, the balance between income and expenses is achieved overall among all accounts.

It should be noted that FIG. 3 and FIG. 4 above are described only as examples, which shall not be deemed as limitations to the protection scope of the present application.

Therefore, embodiments of the application provide a fast goods exchange mode. When some second users with a good credit rating request goods exchange, the server can create a new transaction order according to the first data object information associated with the goods exchange request and provide the new transaction order to the first user (e.g., provisioning user). The first user can execute a goods delivery operation on the first data object according to the new transaction order without waiting for receiving a second data object returned by the second users before delivering the goods. As such, the period that the second user receives the first data object can be shortened, which shortens the period of the entire goods exchange process and improves the efficiency of the goods exchange process.

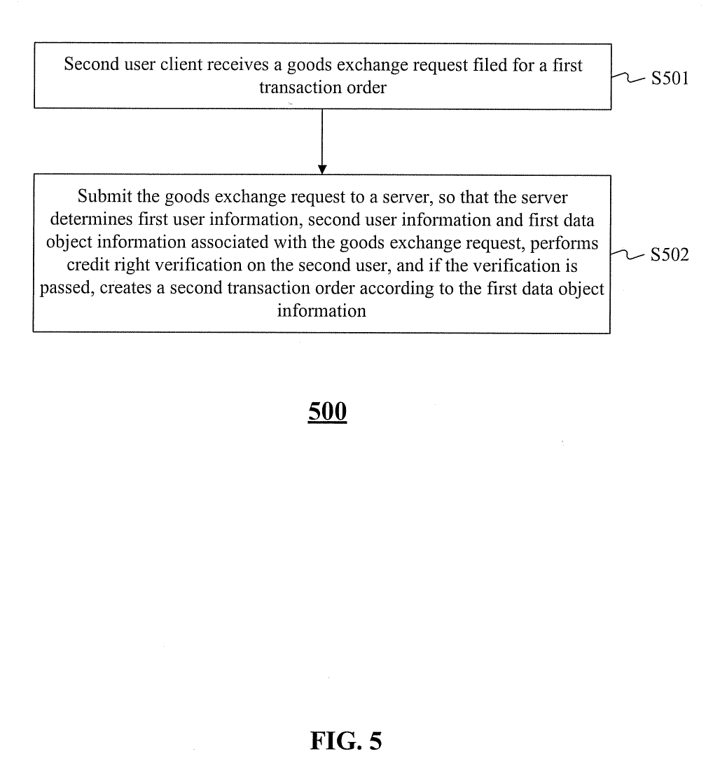

Embodiments of the application further provide a method for processing goods exchange information. FIG. 5 is a flow chart of a method 500 for processing information, according to embodiments of the present application. Method 500 can be implemented by a client terminal of a second user, (e.g., a consuming user). The client terminal of the second user can include a mobile device, a computer system, or the like. Method 500 can comprise steps S501 and S502.

In step S501, the client terminal of the second user can receive a goods exchange request for a first transaction order.

In step S502, the client terminal of the second user can submit the goods exchange request to a server. The server determines first user information, second user information and first data object information associated with the goods exchange request, performs credit right verification on the second user, and if the verification is passed, creates a second transaction order according to the first data object information, and provides the second transaction order to the first user client, so that the first user (e.g., provisioning user) executes a goods delivery operation on the first data object according to the second transaction order.

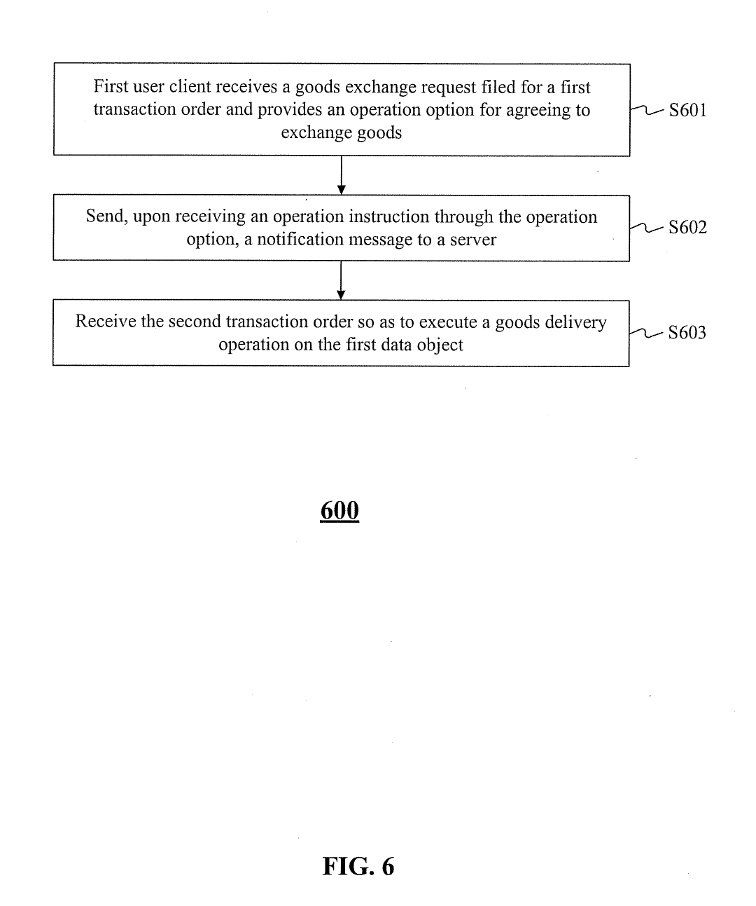

Embodiments of the application further provides a method for processing goods exchange information. FIG. 6 is a flow chart of a method 600 for processing goods exchange information, according to embodiments of the present application. Method 600 can be implemented by a client terminal of a first user (e.g., provisioning user). The client terminal of the first user can include a mobile device, a computer system, or the like. Method 600 can comprise steps S601-S603.

In step S601, the client terminal of the first user can receive a goods exchange request for a first transaction order and provide an operation option for agreeing to goods exchange.

In step S602, the client terminal of the first user can send, upon receiving the agreement of the goods exchange, a notification message to a server. The server can determine first user information, second user information and first data object information associated with the goods exchange request, and verifies the second user (e.g., consuming user). If the second user passes the verification, the server can create a second transaction order according to the first data object information, and returns the second transaction order.

In step S603, the client terminal of the first user can receive the second transaction order, so as to execute a goods delivery operation on the first data object according to the second transaction order.

For example, the client terminal of the first user can also receive a notification message from the server, indicating that resource information has been paid for the second transaction order, so as to execute a goods delivery operation on the first data object according to the notification message. The resource information can be stored in an intermediary account. An operation option for confirming receipt can be provided in the second transaction order, such that upon receiving the second data object associated with the first transaction order, a notification message for confirm receipt can be submitted through the operation option. The notification message can be submitted to the server, so that the server transfers the resource information associated with the second transaction order from the intermediary account into the account associated with the first user.

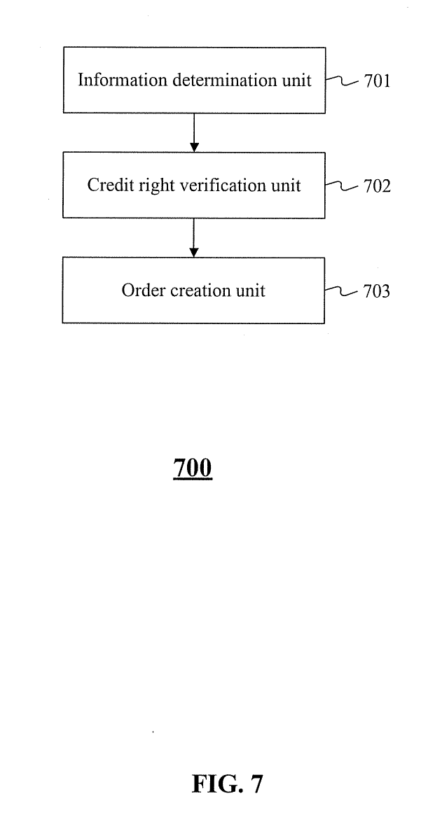

Embodiments of the present application further provide an apparatus for processing goods exchange information. FIG. 7 is a schematic diagram of an apparatus 700 for processing goods exchange information, according to embodiments of the present application. Apparatus 700 can be, e.g., a server. Apparatus 700 can include an information determination unit 701, a verification unit 702, and an order creation unit 703.

Information determination unit 701 can receive a goods exchange request for a first transaction order, and determine first user information, second user information and first data object information associated with the goods exchange request.

Verification unit 702 can verify the second user.

Order creation unit 703 can create, if the second user passes the verification, a second transaction order according to the first data object information, and provide the second transaction order to the first user client. Therefore, the first user can execute a goods delivery operation on the first data object according to the second transaction order.

In addition, apparatus 700 can further include a resource information determining unit and a resource advance payment unit.

The resource information determining unit can determine resource information of the first data object.

The resource advance payment unit can execute a resource advance payment operation for the second transaction order by using a preset advance payment account. Therefore, the first user executes a goods delivery operation on the first data object after receiving the second transaction order and successful payment information.

In some embodiments, the resource advance payment unit can further transfer corresponding resource information into a preset intermediary account and provide a first notification message for successful payment to the first user client.

Furthermore, apparatus 700 can further include a resource transfer unit.

The resource transfer unit can receive, from the first user, a second notification message indicating the returned second data object has been received; and transfer, upon receiving the second notification message, resource information from the intermediary account into the account associated with the first user.

In some embodiments, the resource information associated with the second user for the first transaction order can be stored temporarily in the intermediary account. When the second notification message is received, the resource transfer unit can further return the resource information associated with the first transaction order from the intermediary account into the account associated with the second user; and transfer the resource information associated with the second transaction order from the account associated with the second user into the advance payment account.

Furthermore, apparatus 700 can further include: an authorization information obtaining unit. The authorization information obtaining unit can obtain, before transferring the resource information associated with the second transaction order from the account associated with the second user into the advance payment account, transfer authorization information of the second user.

In some embodiments, apparatus 700 can further include a logistics service provider information determination unit, an address information determination unit, a determination unit, and a marking unit.

The logistics service provider information determination unit can receive a third notification message submitted by the first user, indicating that the goods have been delivered for the second transaction order, and determine the information of the logistics service provider that executes the delivery task.

The address information determining unit can determine first address information associated with the first user and second address information associated with the second user.

The determining unit can determine, according to service coverage information of the logistics service provider, whether the logistics service provider can provide pickup services at the second address and provide delivery services at the first address.

The marking unit can mark, if the logistics service provider can provide the pickup services at the second address and provide the delivery services at the first address, the logistics order associated with the second transaction order, such that a deliverer executes a goods pickup operation on the second goods to be returned by the second user when the first goods corresponding to the first data object is delivered to the second address, and distributes the second goods to the first address.

Apparatus 700 can further include: an information providing unit. The information providing unit can provide the first user identifier information, the second user identifier information, the first address information, and the second address information to the logistics service provider, such that the logistics service provider generates electronic information of receiver and sender for the distribution operation for the second goods, and prints the electronic information.

In some embodiments, the verification unit can determine the resource information of the first data object and the credit limit information of the second user; determine whether the credit limit information of the second user is greater than the resource information of the first data object; and determine whether the verification is passed at least based on the determination result.

Furthermore, in response to the determination that the credit limit information of the second user is greater than the resource information of the first data object and the number of requests for goods exchange within a preset period of time being smaller than a preset threshold value, the verification unit can verify the second user.

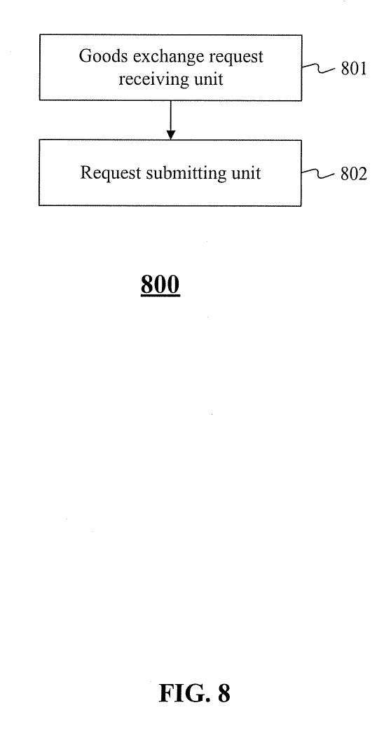

Embodiments of the present application further provide an apparatus for processing goods exchange information. FIG. 8 is a schematic diagram of an apparatus 800 for processing goods exchange information, according to embodiments of the present application. Apparatus 800 can be a client terminal of a second user. The client terminal of the second user can be a computer system, a mobile device, or the like. Apparatus 800 can include a goods exchange request receiving unit 801 and a request submitting unit 802.

Goods exchange request receiving unit 801 can receive a goods exchange request filed for a first transaction order.

Request submitting unit 802 can submit the goods exchange request to a server. Therefore, the server determines first user information, second user information and first data object information associated with the goods exchange request, performs credit right verification on the second user, and if the verification is passed, creates a second transaction order according to the first data object information, and provides the second transaction order to a client of the first user, so that the first user executes a goods delivery operation on the first data object according to the second transaction order.

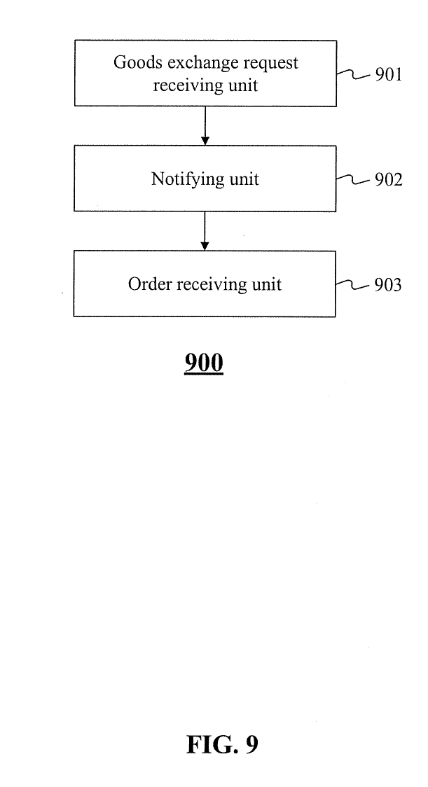

Embodiments of the present application further provide an apparatus for processing goods exchange information. FIG. 9 is a schematic diagram of an apparatus 900 for processing goods exchange information, according to embodiments of the present application. Apparatus 900 can be a client terminal of a first user. The client terminal of the second user can be a computer system, a mobile device, or the like. Apparatus 900 can include a goods exchange request receiving unit 901, a notifying unit 902, and an order receiving unit 903:

Goods exchange request receiving unit 901 can receive a goods exchange request filed for a first transaction order and provide an operation option for agreeing to exchange goods.

Notifying unit 902 can send, upon receiving an operation instruction through the operation option, a notification message to a server, so that the server determines first user information, second user information and first data object information associated with the goods exchange request, performs credit right verification on the second user, and if the verification is passed, creates a second transaction order according to the first data object information, and returns the second transaction order.

Order receiving unit 903 can receive the second transaction order so as to execute a goods delivery operation on the first data object according to the second transaction order.

In summary, a fast goods exchange mode can be provided according to the embodiments of the present application. When some second users with a good credit rating request goods exchange, the server can create a new transaction order according to the first data object information associated with the goods exchange request and provide the new transaction order to the first user. The first user can execute a goods delivery operation on the first data object according to the new transaction order with no need to wait for receiving a second data object returned by the second user before delivering the goods. As such, the period that the second user receives the first data object can be shortened, which shortens the period of the entire goods exchange process and improves the efficiency of the goods exchange process.

According to the description of the above implementation manners, it is appreciated that the present application can be implemented by software plus a necessary general hardware platform. On the basis of such an understanding, the technical solution of the present application can be essentially, or the part of the technical solution contributing to the current technologies can be embodied in a form of a software product. The computer software product can be stored in a storage medium, such as a ROM/RAM, a magnetic disc, an optical disc, and the like, including several instructions that enable a computer device (which can be a personal computer, a server, or a network device) to execute the methods according to the embodiments or some parts of the embodiments of the present application.

The embodiments in this description are described in a progressive manner with each embodiment focused on differences from other embodiments, and the embodiments may be mutually referenced for identical or similar parts thereof. In particular, the functionality provided by the system or system embodiments are substantially similar to the method embodiments, the description thereof is therefore relatively simple, and portions of the method embodiment can be referred to for relevant parts. The system and system embodiments described above are merely exemplary, wherein the units described as separate parts may or may not be physically separated, and the parts displayed as units may or may not be physical units. Namely, they can be disposed at one location or distributed over a plurality of network units. A part or all of the modules thereof can be selected according to actual needs to achieve the goal of the solution of the embodiments. The present application can be understood and implemented by a person skilled in the art with no creative efforts.

The goods exchange information processing method and apparatus according to the present application are described in detail above. Specific examples are used herein to elaborate on the principle and implementation manners of the present application. The description of the above embodiments is only used to help understand the method and core concept of the present application; meanwhile, a person skilled in the art can make changes to both the specific implementation manners and the application scope according to the concept of the present application. In summary, the content of this specification shall not be construed as limitations to the present application.

What is claimed is:

1. A method for processing information, comprising:
receiving, via a server, an exchange request for a first transaction order associated with a first user and a second user;
determining first user information of the first user, second user information of the second user, and information of a first data object associated with the exchange request;
verifying the second user; and
in response to the second user being verified, creating a second transaction order according to the information of the first data object; and
providing the second transaction order to a client terminal of the first user for execution of a delivery of the first data object,
wherein the second transaction order is associated with a second data object corresponding to the first data object.

2. The method according to claim 1, further comprising:
determining first resource information of the first data object; and
executing an advance payment for the second transaction order by using an advance payment account, wherein
the advance payment and the second transaction order correspond to an execution of a delivery of the first data object, and the delivery of the first data object is executed based on the second transaction order and the advance payment.

3. The method according to claim 2, wherein executing the advance payment for the second transaction order by using the advance payment account further comprises:
transferring the first resource information of the first data object into an intermediary account; and
providing a first notification message of the transferring to the client terminal of the first user.

4. The method according to claim 3, further comprising:
determining whether the first user submits a second notification message indicating the second data object has been received; and
transferring, upon receiving the second notification message, the first resource information of the first data object from the intermediary account into an account of the first user.

5. The method according to claim 4, further comprising:
after receiving the second notification message, transferring the first resource information associated with the first transaction order from the intermediary account into an account of the second user; and
transferring second resource information associated with the second transaction order from the account of the second user into the advance payment account.

6. The method according to claim 1, further comprising:
determining whether the first user submits a third notification message indicating the delivery of the first data object has been executed based on the second transaction order;
determining a logistics service provider based on the third notification message;
determining a first address of the first user and a second address of the second user;
determining whether the logistics service provider provides a pickup service at the second address and a delivery service at the first address; and
in response to the determination that the logistics service provider provides the pickup service at the second address and the delivery service at the first address, instructing the logistics service provider to pick up the second data object while delivering the first data object to the second address.

7. The method according to claim 6, wherein the first user information at least includes first user identifier information and the first address, and the second user information at least includes second user identifier information and the second address, and the method further comprises:
providing the first user identifier information, the second user identifier information, the first address information, and the second address information to the logistics service provider.

8. The method according to claims 1, wherein verifying the second user further comprises:
determining the resource information of the first data object and the credit information of the second user;
determining whether the credit information of the second user satisfies the resource information of the first data object; and
determining that the second user is verified based on the determination.

9. The method according to claim 8, wherein determining that the second user is verified based on the determination further comprises:
in response to the credit information of the second user satisfying the resource information of the first data object, further determining whether a number of exchange requests initiated by the second user within a period of time is less than a threshold value; and
in response to the number of exchange requests being less than the threshold value, the second user is verified.

10. An apparatus for processing information, comprising:
a memory storing a set of instructions; and
at least one processor configured to execute the set of instruction to cause the apparatus to perform:
receiving an exchange request for a first transaction order associated with a first user and a second user;
determining first user information of the first user, second user information of the second user, and information of a first data object associated with the exchange request;
verifying the second user; and
in response to the second user being verified, creating a second transaction order according to the information of the first data object; and
providing the second transaction order to a client terminal of the first user for execution of a delivery of the first data object,
wherein the second transaction order is associated with a second data object corresponding to the first data object.

11. The apparatus according to claim 10, wherein the at least one processor is further configured to execute the set of instruction to cause the apparatus to perform:
determining first resource information of the first data object; and
executing an advance payment for the second transaction order by using an advance payment account, wherein
the advance payment and the second transaction order correspond to an execution of a delivery of the first data object, and the delivery of the first data object is executed based on the second transaction order and the advance payment.

12. A non-transitory computer-readable medium that stores a set of instruction that is executable by at least one processor of a sever to cause the sever to perform a method for processing information, the method comprising:
receiving an exchange request for a first transaction order associated with a first user and a second user;
determining first user information of the first user, second user information of the second user, and information of a first data object associated with the exchange request;
verifying the second user; and
in response to the second user being verified, creating a second transaction order according to the information of the first data object; and
providing the second transaction order to a client terminal of the first user for execution of a delivery of the first data object,
wherein the second transaction order is associated with a second data object corresponding to the first data object.

13. The non-transitory computer-readable medium according to claim 12, wherein the set of instruction is executable by the at least one processor of the sever to cause the sever to further perform:
determining first resource information of the first data object; and
executing an advance payment for the second transaction order by using an advance payment account, wherein
the advance payment and the second transaction order correspond to an execution of a delivery of the first data object, and the delivery of the first data object is executed based on the second transaction order and the advance payment.

14. The non-transitory computer-readable medium according to claim 13, wherein executing the advance payment for the second transaction order by using the advance payment account further comprises:
transferring the first resource information of the first data object into an intermediary account; and
providing a first notification message of the transferring to the client terminal of the first user.

15. The non-transitory computer-readable medium according to claim 14, wherein the set of instruction is executable by the at least one processor of the sever to cause the sever to further perform:
determining whether the first user submits a second notification message indicating the second data object has been received; and
transferring, upon receiving the second notification message, the first resource information of the first data object front the intermediary account into an account of the first user.

16. The non-transitory computer-readable medium according to claim 15, the set of instruction is executable by the at least one processor of the sever to cause the sever to further perform:
after receiving the second notification message, transferring the first resource information associated with the first transaction order from the intermediary account into an account of the second user; and
transferring second resource information associated with the second transaction order from the account of the second user into the advance payment account.

17. The non-transitory computer-readable medium according to claim 12, the set of instruction is executable by the at least one processor of the sever to cause the sever to further perform:
determining whether the first user submits a third notification message indicating the delivery of the first data object has been executed based on the second transaction order;
determining a logistics service provider based on the third notification message;
determining a first address of the first user and a second address of the second user;
determining whether the logistics service provider provides a pickup service at the second address and a delivery service at the first address; and
in response to the determination that the logistics service provider provides the pickup service at the second address and the delivery service at the first address, instructing the logistics service provider to pick up the second data object while delivering the first data object to the second address.

18. The non-transitory computer-readable medium according to claim 17, wherein the first user information at least includes first user identifier information and the first address, and the second user information at least includes second user identifier information and the second address, and the set of instruction is executable by the at least one processor of the sever to cause the sever to further perform:
providing the first user identifier information, the second user identifier information, the first address information, and the second address information to the logistics service provider.

19. The non-transitory computer-readable medium according to claim 12, wherein verifying the second user further comprises:
determining the resource information of the first data object and the credit information of the second user;
determining whether the credit information of the second user satisfies the resource information of the first data object; and
determining that the second user is verified based on the determination.

20. The non-transitory computer-readable medium according to claim 19, wherein determining that the second user is verified based on the determination further comprises:
in response to the credit information of the second user satisfying the resource information of the first data object, further determining whether a number of exchange requests initiated by the second user within a period of time is less than a threshold value; and
in response to the number of exchange requests being less than the threshold value, the second user is verified.
